(19) United States
(12) Patent Application Publication
(10) Pub. No.: US 2004/0090535 A1
(43) Pub. Date: May 13, 2004

(54) Digital camera using a solid image capturing element having a mosaic color filter

(75) Inventor: Tohru Watanabe, Ogaki-shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/648,044

(22) Filed: Aug. 26, 2003

(30) Foreign Application Priority Data
Aug. 29, 2002 (JP) 2002-251628
Jul. 7, 2003 (JP) 2003-271584

(51) Int. Cl. H04N 5/228

(52) U.S. Cl. 348/222.1

(57) ABSTRACT

A color image capturing device using a mosaic color filter, which can enhance sensitivity of a brightness signal while suppressing cost increase. Line transfer from the accumulation section 11v is conducted twice successively so that a combined line which is combination of two lines is created in the horizontal transfer section 11h. In a combined line, addition <R+G> of R component and G component and addition <G+B> of G component and B component are alternately arranged. A divided reset clock φ r′ for the output section 11d is set to have a cycle twice as long as the cycle of a horizontal transfer clock φh, and the phase of φr′ is set being displaced by an amount corresponding to one cycle of φh between an odd-numbered combined line and an even-numbered combined line. Consequently, data D (R+G) corresponding to <R+G> and data D (R+2G+B) corresponding to addition <R+G> and <G+B> are alternately obtained relative to an odd-numbered line, while data D (G+B) corresponding to <G+B> and data D (R+2G+B) corresponding to addition <R+G> and <G+B> are alternately obtained relative to an even-numbered line. Using data D(R+2G+B), which is data obtained by combining four pixels, as a brightness signal, sensitivity of the image capturing device can be enhanced. Color signals are obtained from data D(R+G) and D(G+B).

### BACKGROUND OF THE INVENTION

1. Field of the Invention

The present invention relates to an image capturing device for capturing a color image using a solid image capturing element having a mosaic color filter.

2. Description of the Related Art

An example of a conventional image capturing device is a digital camera which uses a CCD (charge coupled device) image sensor capture images. Such digital cameras have an image capturing mode, generally referred to as a monitor mode, in which an image of an object is displayed on a display screen so that a user can actually see and study the image which would be captured. Compared to image capturing of a still image for accumulation in a memory as a picture of an object, a monitor mode does not require a particularly high resolution.

In recent years, digital cameras have come to be installed in devices such as, for example, portable phones, so that a user is able to use a digital camera whenever that user has their phone with them. In such digital cameras, high resolution is not as important as the monitor mode in general-use digital cameras because the display screens of such internal cameras are smaller than those of general-use digital cameras. For these internal cameras, size and cost reduction are greater demands.

FIG. 1 is a block diagram schematically showing a structure of a conventional image capturing device which comprises a CCD image sensor (solid image capturing element) 1, a CCD driver circuit 2, a timing control circuit 6, an analogue signal processing circuit 3, an A/D conversion circuit 4, and a digital signal processing circuit 5.

The CCD image sensor 1, which has a light receiving area where a plurality of light receiving pixels are arranged in a matrix, receives light incident to the light receiving surface by each of the light receiving pixels and generates information charges through photoelectric conversion. The CCD image sensor 1 accumulates the information charges in each of the light receiving pixels for a predetermined accumulation period and thereafter sequentially transfers the charges through a plurality of shift registers. The transferred charges are then converted into a voltage value in an output section provided at the last stage of the transfer path and output as an image signal Y0(t).

There are at least several types of solid image capturing elements for sequentially transferring accumulated information charges to output an image signal, as described above; among these are a frame transfer type, in which information charges accumulated in an image capturing section are collectively transferred to a storage section; an interline type, in which information charges are transferred to a vertical transfer section provided between light receiving pixel columns; and a frame interline type, which has features of the frame transfer type and the interline type.

The CCD driver circuit 2 generates a plurality of clock pulses in synchronism with a vertical synchronous signal VT and a horizontal synchronous signal HT, both supplied from a timing control circuit 6, described later, and supplies the generated clock pulses to the CCD image sensor 1 to drive the CCD image sensor 1 for sequential transfer of information charges accumulated therein.

The analogue signal processing circuit 3 performs analogue signal processing, including CDS (Correlated Double Sampling) and AGC (Automatic Gain Control), on an image signal Y0(t) output from the CCD image sensor 1 to generate an image signal Y1(t).

The A/D conversion circuit 4 normalizes an image signal Yl (t) in synchronism with operation of the CCD image sensor 1 to convert the signal into a digital signal for output as image data Y0(n).

The digital signal processing circuit 5 performs digital signal processing, including color separation and matrix operation, on image data output from the A/D conversion circuit 4 to generate image data Y1(n), containing brightness data and color difference data.

The timing control circuit 6 generates a vertical synchronous signal VT and a horizontal synchronous signal HT while counting a reference clock CK, to determine periods of time for vertical and horizontal scanning by the CCD image sensor 1. For example, in the NTSC method, the frequency of a reference clock CK, which is four time the frequency of a color sub-carrier, or 3.58 MHz, used in signal processing, is divided into 1/910 to thereby generate a horizontal synchronous signal HT and the frequency of the resultant horizontal synchronous signal HT is further divided into 2/525 to thereby generate a vertical synchronous signal VT.

In an image capturing device which obtains image data through various signal processing applied to an image signal output from a solid image capturing element, as described above, exposure control is applied for adjustment of a period of time during which information charges are accumulated, according to the illumination of an object. The exposure control for extending or reducing the accumulation period may be performed based on the illumination of an object measured by a light meter sensor, or with reference to an integral value of image information accumulated during a certain period.

In the latter method, for example, feedback control may be applied such that an accumulation period for the CCD image sensor 1 is reduced when an integral value of image data exceeds a suitable range and increased when an integral value underperforms a suitable range. With this arrangement, the illumination range of the CCD image sensor 1 is expanded, so that suitable image information according to the illumination of an object can be obtained.

In a case wherein sufficient exposure cannot be obtained even when exposure control is applied using any of the above methods, the illumination range can be further expanded by combining information charges obtained in each light receiving pixel. Specifically, when the illumination of an object is so low that sufficient information charges cannot be obtained, information charges obtained by adjacent receiving pixels combined to create a combined signal associated with two or more pixels for compensation for the lack of image information. With the above arrangement, image information at a sufficient level is ensured while avoiding under exposure even for a dark object.

### SUMMARY OF THE INVENTION

For color image capturing using the above described image capturing device, a color filter is mounted on the light receiving surface of the solid image capturing element. The color filter comprises segments for three primary colors and their complementary colors, regularly arranged in a predetermined order such that each segment is correlated to each of the light receiving pixels of the solid image capturing element. For a mosaic color filter, for example, as shown in FIG. 9, color filter segments for green (G) and red (R) colors are alternately arranged in an odd-numbered line, while color filter segments for green (G) and blue (B) colors are alternately arranged in an even-numbered line. Such a color filter, however, is disadvantageous in view of color reproductivity in such a use that information charges are combined because two adjacent color filter segments are of different colors.

In order to obviate this problem, the present applicant suggests an image capturing device in Japanese Patent Laid-open Publication No. Hei 8-154253. According to this image capturing device, different number of bits are provided in odd and even-numbered lines in a vertical transfer section and information charges obtained in the light receiving pixels in odd-numbered lines and those in even-numbered lines are alternately output so that information charges for identical color components become continuous in the horizontal transfer section. This image capturing device, however, is not suitable for production of low-priced products as it requires modification of a device structure of the solid image capturing element, and thus inevitably increase manufacturing costs;

In view of the above, the present invention advantageously produces an image capturing device which can improve the sensitivity of a brightness signal, while preventing cost increase, in color image capturing using a mosaic color filter.

According to one aspect of the present invention, there s provided an image capturing device comprising a solid image capturing element having a plurality of light receiving pixels arranged in a matrix, for accumulating information charges therein. In the solid image capturing element, the light receiving pixels in an odd-numbered line are alternately correlated to a first color component and a second color component and the light receiving pixels in an even-numbered line are alternately correlated to the second color component and a third color component. The light receiving pixels are connected to a plurality of vertical shift registers. Outputs from the plurality of vertical shift registers are respectively coupled to respective bits of a horizontal shift register. An output from the horizontal shift register is coupled to an output section.

The image capturing device further comprises a driving circuit for transferring the information charges accumulated in the plurality of light receiving pixels from the plurality of vertical shift registers to the horizontal shift register. The driving circuit further combines, during a process of transferring the information charges, the information charges for every k-number of lines (k being a natural number) to thereby create a first combined charge and a second combined charge which are alternately accumulated in the respective bits of the horizontal shift register, in which the first combined charge is a combination of the first color component and the second color component, and the second combined charge is a combination of the second color component and the third color component. The driving circuit also accumulates the first combined charge and the second combined charge, sent from the horizontal shift register in the units of one bits, for m-number of bits (m being a natural number, either k or m being larger than one) in the output section to thereby create a first output, a second output, and a third output, in which the first output is a combination of the first color component, the second color component, and the third color component weighted according to a first ratio, the second output is a combination of the first color component, the second color component, and the third color component weighted according to a second ratio, and the third output is a combination of the first color component, the second color component, and the third color component weighted according to a third ratio.

The image capturing device further comprises a sample hold circuit for sampling an output from the solid image capturing element to produce a first image signal in response to the first output, a second image signal in response to the second output, and a third image signal in response to the third output, and a signal processing circuit for applying predetermined signal processing to an image signal produced by the sample hold circuit. In this image capturing device, the signal processing circuit generates color component signals respectively expressing the first color component, the second color component, and the third color component, using the first image signal, the second image signal, and the third image signal.

According to another aspect of the present invention, there is provided an image capturing device comprising a solid image capturing element having a plurality of light receiving pixels arranged in a matrix, for accumulating information charges therein. In the solid image capturing element, the light receiving pixels in an odd-numbered line are alternately correlated to a first color component and a second color component and the light receiving pixels in an even-numbered line are alternately correlated to the second color component and a third color component. The light receiving pixels are connected to a plurality of vertical shift registers. Outputs from the plurality of vertical shift registers are respectively coupled to respective bits of a horizontal shift register. An output from the horizontal shift register being coupled to an output section.

The image capturing device further comprises a driving circuit for transferring the information charges accumulated in the plurality of light receiving pixels from the plurality of vertical shift registers to the horizontal shift register. The driving circuit also combines, during a process of transferring the information charges, the information charges for every k-number of lines (k being a natural number) to thereby create a first combined charge and a second combined charge which are alternately accumulated in the respective bits of the horizontal shift register, in which the first combined charge is a combination of the first color component and the second color component, and the second combined charge is a combination of the second color component and the third color component.

The driving circuit still further accumulates the first combined charge and the second combined charge, sent from the horizontal shift register in the units of one bits, for m-number of bits (m being a natural number, either k or m being larger than one) in the output section to thereby create a first output, a second output, and a third output, in which the first output is a combination of the first color component, the second color component, and the third color component weighted according to a first ratio, the second output is a combination of the first color component, the second color component, and the third color component weighted according to a second ratio, and the third output is a combination of the first color component, the second color component, and the third color component weighted according to a third ratio.

The image capturing device further comprises a sample hold circuit for sampling an output from the solid image capturing element to produce a first image signal in response to the first output, a second image signal in response to the second output, and a third image signal in response to the third output, and a signal processing circuit for applying predetermined signal processing to an image signal produced by the sample hold circuit. In the image capturing device, the signal processing circuit generates a color component signal which approximates at least one color component among the first color component, the second color component, and the third color component, using the first image signal, the second image signal, and the third image signal.

According to still another aspect of the present invention, there is provided an image capturing device comprising a solid image capturing element having a plurality of light receiving pixels arranged in a matrix, for accumulating information charges therein. In the solid image capturing element, the light receiving pixels in an odd-numbered line being alternately correlated to a first color component and a second color component. The light receiving pixels in an even-numbered line are alternately correlated to the second color component and a third color component. The light receiving pixels are connected to a plurality of vertical shift registers. Outputs from the plurality of vertical shift registers are respectively coupled to respective bits of a horizontal shift register. An output from the horizontal shift register being coupled to an output section.

The image capturing device further comprises a driving circuit for transferring the information charges accumulated in the plurality of light receiving pixels from the plurality of vertical shift registers to the horizontal shift register. The driving circuit further combines, during a process of transferring the information charges, the information charges for every two lines to thereby create a first combined charge and a second combined charge which are alternately accumulated in the respective bits of the horizontal shift register, in which the first combined charge is a combination of the first color component and the second color component, and the second combined charge is a combination of the second color component and the third color component. The driving circuit still further accumulates the first combined charge and the second combined charge, sent from the horizontal shift register in the units of one bits, for two bits in the output section to thereby create a first output and a second output, in which the first output is in according with an amount of the first combined charge or the second combined charge and the second output is in accordance with an amount of the first combined charge and the second combined charge.

The image capturing device further comprises a sample hold circuit for sampling an output from the solid image capturing element to produce a first image signal in response to the first output and a second image signal in response to the second output and a signal processing circuit for applying predetermined signal processing to an image signal produced by the sample hold circuit In the image capturing device, the signal processing circuit generates a first color component signal which approximates the first color component or the third color component, using the first image signal, and a second color component signal which approximates the second color component, using the second image signal.

In an image capturing device of the present invention, the solid image capturing element and the horizontal shift register are activated once for every second driving of the vertical shift register, so that information charges obtained by two vertically successive pixels are accumulated as combined charges in a single bit in the horizontal shift register.

It should be noted that a horizontal alignment of combined charges held in the horizontal shift register is referred to as a combined line. Through the above described vertical combining, one combined line is created for every two horizontal lines (rows) of light receiving pixels. A combined charge among those constituting the i-th line of a combined line and held in a bit of a horizontal shift register, which corresponds to the j-th column of light receiving pixels is denoted as Q (i,j) here.

In a combined line, a first combined charge which is obtained by combining a first color component and a second color component, and a second combined charge which is obtained by combining a second color component and a third color component are alternately arranged.

When, after formation of a combined line, the horizontal shift register is activated and the output section is set so as to discharge information charges accumulated therein for every two transfers of combined charge packets from the horizontal shift register to the output section, two combined charge packets are combined in a stepwise manner in the output section. The output section then outputs a voltage which takes stepwisely different values according to the amount of the accumulated charges, in which a stepwisely different value of the output signal corresponds to a different color combining ratio (that is, a ratio of the number of pixels having different color sensitivities).

Specifically, a first output is discharged when one combined charge is held in the output section. Then, when the first output is sampled, a first image signal is produced. Similarly, a second output is discharged when two combined charges are held in the output section. Then, when the second output is sampled, a second image signal is produced.

Depending on the phase of discharging operation for discharging information charges from the output section, a first image signal may have a value in accordance with the amount of a first combined charge or a value in accordance with the amount of a second combined charge. Specifically, a first image signal based on a first combined charge and a first image signal based on a second combined charge can be alternatively obtained, for example, according to the arrangement of the first and second combined charges in a combined line. A second image signal has a value in accordance with the amount of first and second combined charges combined.

According to whether the first image signal is based on a first or second combined charge, the signal processing circuit generates either a first color component signal which approximates a first color component or a third color component signal which approximates a third color component. A second image signal is obtained by combining information charges for four pixels, two of which are correlated to the second color component. The signal processing circuit generates a second color component signal which approximates a second color component, using the second image signal.

Thereafter, a brightness signal and a color signal are generated using a plurality of the generated image signals. That is, when the combined charge packets obtained by combining information charges in a vertical direction are further combined in a horizontal direction, a brightness signal with further enhanced sensitivity can be obtained. Further, because a color signal can additionally be obtained, color image displaying is possible.

In one configuration of the present invention, the first color component, the second color component, and the third color component are three optical primary colors including red, green, and blue, and the second color component is green.

As described above, according to the present invention, there is provided an image capturing device using a solid image capturing element having a mosaic color filter. This device is able to enhance the sensitivity of a brightness signal and provide color information, while simultaneously suppressing cost increase.

### BRIEF DESCRIPTION OF THE DRAWINGS

FIG. 1 is a block diagram schematically showing a structure of an image capturing device of the present invention;

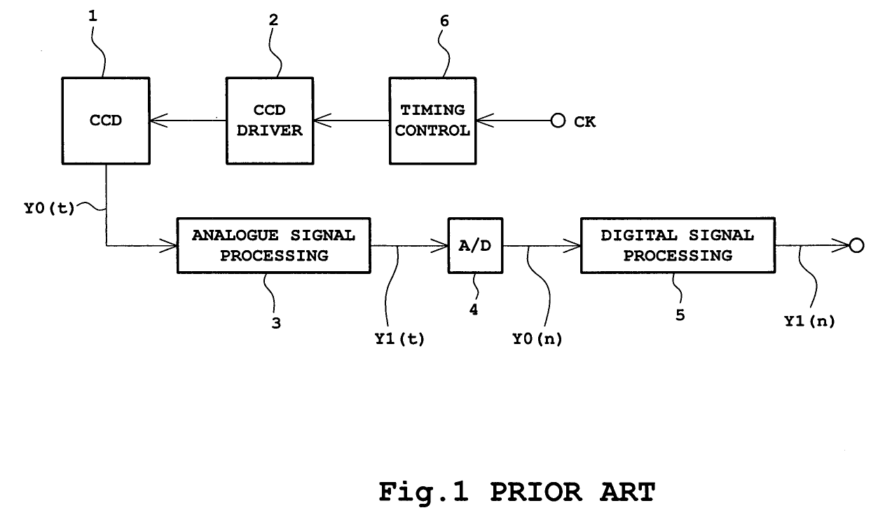

FIG. 2 is a diagram showing timing for vertical and horizontal scanning by a solid image capturing element in an enhanced operation mode;

FIG. 3 is a diagram showing timing for horizontal scanning of an odd-numbered combined line;

FIG. 4 is a diagram showing timing for horizontal scanning of an even-numbered combined line;

FIG. 5 is a diagram showing pixel combination and approximate color data when combining information charges in two lines in a first embodiment of the present invention;

FIG. 6 is a diagram showing pixel combination and approximate color data when combining information charges in three lines in a second embodiment of the present invention;

FIG. 7 is a diagram showing pixel combination and approximate color data when combining information charges in four lines in a third embodiment of the present invention;

FIG. 8 is a block diagram schematically showing a structure of a conventional image capturing device; and

FIG. 9 is a diagram schematically showing a structure of a mosaic color filter.

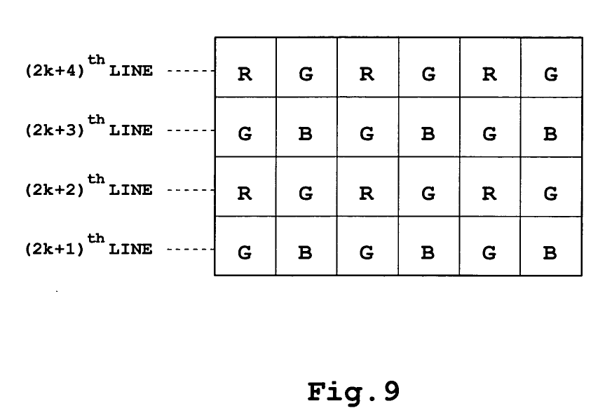

### DESCRIPTION OF THE PREFERRED EMBODIMENTS

In the following, preferred embodiments of the present invention will be described with reference to the accompanied drawings.

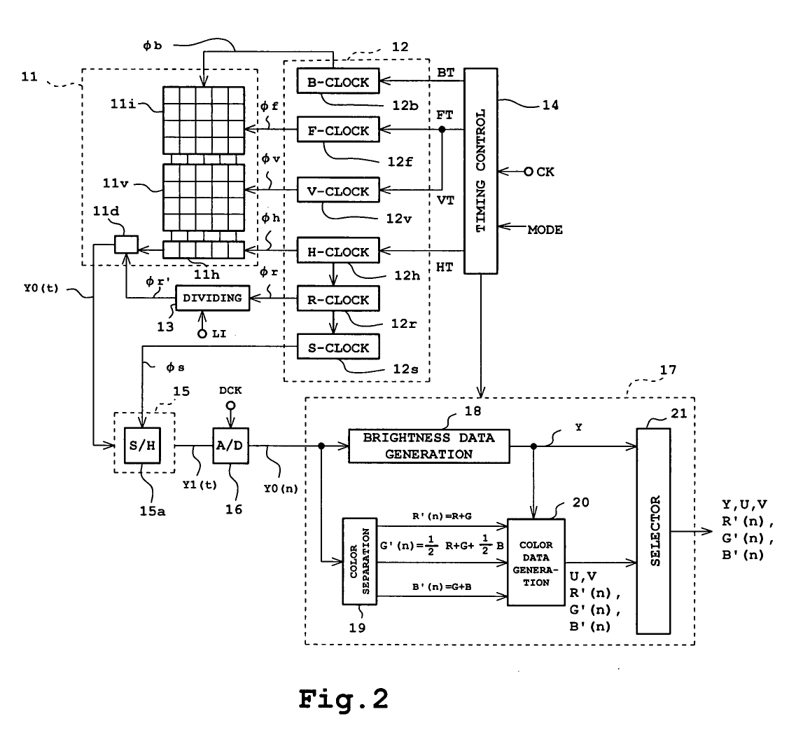

FIG. 2 is a block diagram schematically showing a structure of an image capturing device according to a first embodiment of the present invention. The depicted image capturing device comprises a solid image capturing element 11, a CCD driver circuit 12, a dividing circuit 13, a timing control circuit 14, an analogue signal processing circuit 15, an A/D conversion circuit 16, and a digital signal processing circuit 17. This device has an operation mode in which information charges obtained by two or more pixels are combined under low illumination image capturing condition to thereby enhance sensitivity of a brightness signal to obtain faithful color components. This mode is hereinafter referred to as an enhanced operation mode. In an enhanced operation mode, information charges obtained by two or more pixels in the solid image capturing element 11 where pixels are arranged in a matrix are combined respectively in column (or vertical) and row (or horizontal) directions.

The solid image capturing element 11 may be, for example, a frame transfer type and comprises an image capturing section 11i, an accumulation section 11v, a horizontal transfer section 11h, and an output section 11d.

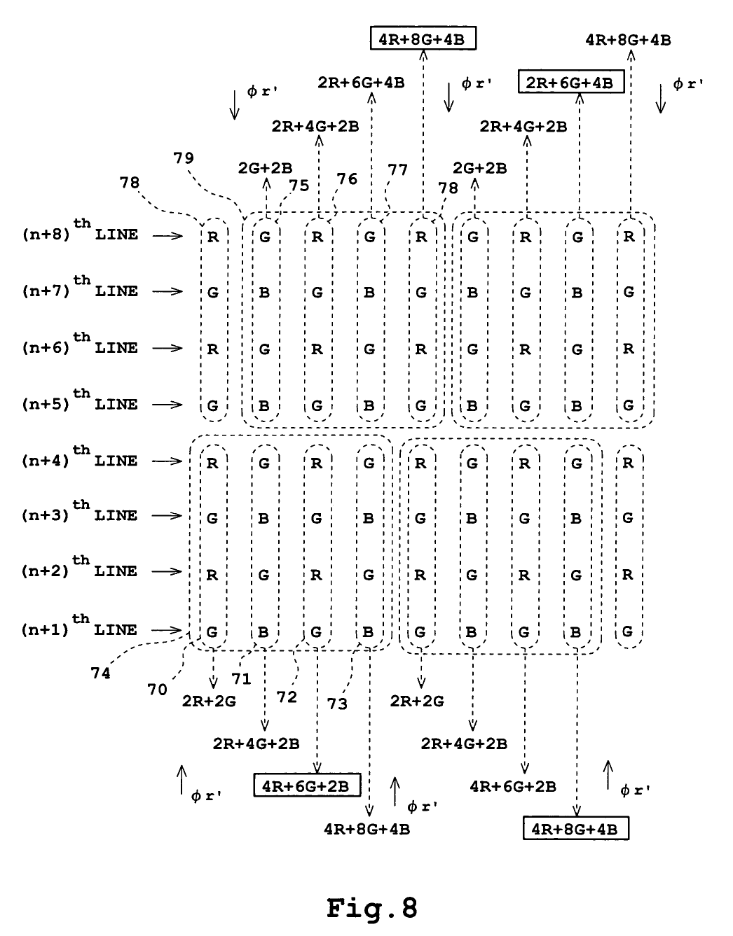

The image capturing section 11i comprises a plurality of vertical shift registers, of which each bit constitutes one of a plurality of light receiving pixels arranged in a matrix. A color filter for color image capturing is mounted on the surface of the image capturing section 11i such that each segment of the color filter is correlated to each of the plurality of light receiving pixels. For a mosaic color filter as shown in FIG. 8, for example, light receiving pixels in odd rows are correlated alternately to blue color (B) and green color (G), and those in even rows are correlated alternately to green color (G) and red color (R). An OPB (optical black) region, in which parts of the plurality of vertical shift registers are light-shielded, is formed in the image capturing section 11i and information charges obtained in this region are used in determination of the black level of image information.

The accumulation section 11v comprises a plurality of vertical shift registers which are continuous from the plurality of vertical shift registers which constitute the image capturing section 11i. The accumulation section 11v has a same number of bits as that of the image capturing section 11i.

The horizontal transfer section 11h comprises a single horizontal shift register provided on the output side of the accumulation section 11v and is connected such that outputs from the plurality of vertical shift registers of the accumulation section 11v are supplied to the respective bits of the horizontal transfer section 11h.

The output section 11d, provided on the output side of the horizontal transfer section 11h, has a capacity for storing information charges output from the horizontal transfer section 11h. The output section 11d outputs, as an image signal Y0(t), a voltage corresponding to the amount of information charges received from the horizontal transfer section 11h and accumulated therein.

The thus constructed solid image capturing element 11 of a frame transfer type has an LOD (Lateral Overflow Drain) structure or a VOD (Vertical Overflow Drain) structure and, regardless of the type, can discharge information charges accumulated in the image capturing section 11i. By discharging the information charges, the state of accumulation of information charges in the image capturing section 11i is reset.

The CCD driver circuit 12 comprises a B-clock generating section 12b, an F-clock generating section 12f, a V-clock generating section 12v, an H-clock generating section 12h, an R-clock generating section 12r, and an S-clock generating section 12s and supplies clock pulses generated by the respective generating sections to the solid image capturing element 11.

Specifically, the B-clock generating section 12b generates a discharge clock φb in response to a discharge timing signal BT from the timing control circuit 14. The discharge clock φb is applied to an overflow drain region of a solid image capturing element 11 when the element 11 has an LOD structure, and to a substrate side of the solid image capturing element 11 when the element 11 has a VOD structure.

The F-clock generating section 12f responsive to a frame shift timing signal FT from the timing control circuit 14 generates a frame transfer clock φf of, for example, four phases to supply to the image capturing section 11i. The V-clock generating section 12v responsive to a vertical synchronous signal VT supplied from the timing control circuit 14 generates a line transfer clock φ v of, for example, four phases to supply to the accumulation section 11v. The H-clock generating section 12h responsive to a horizontal synchronous signal HT supplied from the timing control circuit 14 generates a horizontal transfer clock φh of, for example, two phases to supply to the horizontal transfer section 11h. The R-clock generating section 12r generates a reset clock φr in synchronism with the H-clock generating section 12h to supply via the dividing circuit 13 to the output section 11d. The S-clock generating section 12s generates a sampling clock φs based on a horizontal transfer clock Oh to supply to the sample hold circuit 15a.

The dividing circuit 13 receives a reset clock φr from the R-clock generating section 12r and divides, when necessary, the frequency of the reset clock φr to thereby generate a divided reset clock φr′. Specifically, the dividing circuit 13 generates a divided reset clock φr′ in an enhanced operation mode so that the output section 11d is reset intermittently. That is, information charges held in a plurality of bits of the horizontal transfer section 11h are accumulated in the capacity of the output section 11d. This allows pixel combining in the horizontal direction in an enhanced operation mode.

In an example wherein the frequency of a reset clock φr is divided to half to thereby double the reset cycle of the output section 11d, information charges held in two bits of the horizontal transfer section 11h are sequentially accumulated in the output section 11d. Therefore, a voltage corresponding to the amount of information charges for one bit of the horizontal transfer section and a voltage corresponding to the amount of information charges for two bits are alternately output from the output side of the output section 11d.

It should be noted that the dividing circuit 13 selectively applies frequency dividing depending on whether an image capturing device is in a normal or enhanced operation mode. That is, when sufficient exposure is ensured in the image capturing section 11i, or in a normal operation mode, the dividing circuit 13 does not apply frequency dividing and, therefore, a reset clock φr output from the R-clock generating section 12r is applied intact to the output section 11d. In under-exposure conditions, on the other hand, an enhanced operation mode is activated in which the dividing circuit 13 applies frequency dividing so that information charges can be combined, as described above.

The timing control circuit 14 comprises a plurality of counters each for counting a reference clock CK and generates a vertical synchronous signal VT and a horizontal synchronous signal HT as well as a frame shift timing signal FT. The timing control circuit 14 also generates a discharge timing signal BT based on the illumination of an object measured by a light meter sensor or a value calculated based on an integral value of image data obtained in the digital signal processing circuit 17. The vertical synchronous signal VT, the horizontal synchronous signal HT, the frame shift timing signal FT, and a discharge timing signal BT are all supplied to the CCD driver circuit 12. The timing control circuit 14 additionally supplies a control signal to the analogue signal processing circuit 15, the A/D conversion circuit 16, and the digital signal processing circuit 17 so that the operational timing of these circuits is synchronized.

The timing control circuit 14, which begins operating upon receipt of a mode signal MODE, controls the V-clock generating section 12v and the H-clock generating section 12h such that, in an enhanced operation mode, the horizontal transfer section 11h is driven after several times of reading of information charges read from the accumulation section 11v to the horizontal transfer section 11h, and horizontally transfers the information charges accumulated therein to the output section 11d.

The analogue signal processing circuit 15 comprises a sample hold circuit 15a and performs analogue signal processing, including CDS and AGC, on an image signal Y0(t) output from the solid image capturing element 11. The sample hold circuit 15a samples an image signal Y0(t) which repetitively become of a signal level and a reset level, in a cycle according to a sampling clock φs supplied from the S-clock generating section 12s, and produces only an image signal Y1(t) at a signal level.

A sampling clock φs to be supplied to the sample hole circuit 15a has a cycle identical to that of a horizontal transfer clock φh. Therefore, an image signal Y1(t) is produced every reading of information charges for one bit of the horizontal transfer section 11h to the output section 11d. Therefore, in an enhanced operation mode, a signal at a level corresponding to information charges for one bit of a horizontal transfer section and a signal at a level corresponding to combined information charges for two bits are alternately output as an image signal Y1(t).

The A/D conversion circuit 16 receives an image signal Y1(t) from the analogue signal processing circuit 15 and converts it into a digital signal to output as an image data Y0(n). In the conversion, the A/D conversion circuit 16 normalizes an image signal Y1(t) according to a sampling clock for A/D conversion DCK, supplied from the timing control circuit 14. A sampling clock for A/D conversion DCK has a cycle identical to that of a horizontal transfer clock φh, similar to a sampling clock φs. Therefore, in an enhanced operation mode, the A/D conversion circuit 16 alternately outputs data corresponding to the amount of information charges for one bit of the horizontal transfer section 11h and data corresponding to the amount of information charges for a plurality of bits.

The digital signal processing circuit 17 comprises a brightness data generating circuit 18, a color separating circuit 19, a color data generating circuit 20, and a selector 21. The brightness data generating circuit 18 receives image data Y0(n) from the A/D conversion circuit 16 and stores image data Y0(n) for a plurality of horizontal lines of the image capturing element 11 in its line memory to perform a predetermined operation on the data stored therein to generate brightness data Y.

The color separating circuit 19 receives image data Y0(n) from the A/D conversion circuit 16 and separates, from the image data Y0(n), color component data R′(n), G′(n), and B′(n) for the respective colors RGB.

The color data generating circuit 20 receives color component data R′(n), G′(n), and B′(n) from the color separating circuit 19 and also brightness data Y from the brightness data generating circuit 18 and generates color difference signals U and V. Specifically, the color data generating circuit 20 generates a color difference signal U by deducting brightness data Y from the color component data R′(n), and a color difference signal V by deducting brightness data Y from the color component data B′(n). The color data generating circuit 20 outputs the resultant color difference signals U and V and also, simultaneously, the color component data R′(n), G′(n), and B′(n) received from the color separation circuit 19.

The selector 21 receives data from the brightness data generating circuit 18 and data from the color data generating circuit 20 and selectively outputs appropriate data to fulfill requests from data recipients.

The digital signal processing circuit 17 additionally comprises an exposure control circuit and a white balance control circuit, not shown. The exposure control circuit expands or reduces the period of time for accumulation of information charges, or an accumulation period, according to the state of exposure in the solid image capturing element 11. Additionally, the exposure control circuit switches between normal and enhanced operation modes.

A white balance control circuit multiplies each of the color component data by a unique gain coefficient to thereby adjust balance between the respective color component data to enhance color reproductivity of a reproduced image. Generally, in white balance control, color component data is integrated for every one or more screen images and adjustment is made through feedback control such that these integrated values become equal to one another.

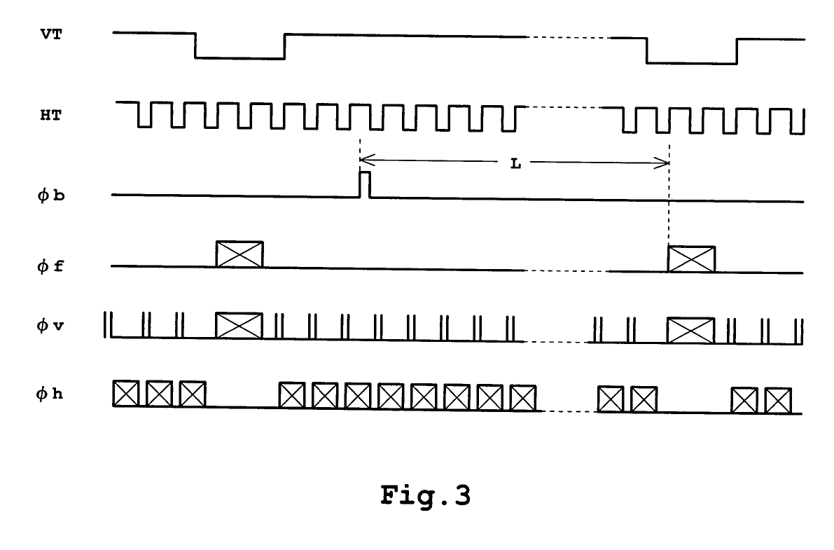

In the following, referring to FIGS. 3 to 6, operation of the image capturing device of FIG. 2 in an enhanced operation mode will be described.

FIG. 3 is a diagram showing timing for operation of the solid image capturing element 11. It should be noted that, in this drawing, the frame transfer clock φf, a line feeding clock φ v, and a horizontal transfer clock φh are each a multiple-phase clock pulse and one of the multiple phases is shown as a representative clock pulse.

A discharge clock φb is a clock which causes the potential on the substrate side of a solid image capturing element 11 of a VOD structure to temporarily rise to a higher potential side, so that information charges accumulated in the image capturing section 11i are discharged to the substrate side. A frame transfer clock φf clocks in a blanking period in a vertical scanning period 1V, so that information charges for one image screen, which are accumulated in the image capturing section 11i, are output to the accumulation section 11v at a high speed. With the solid image capturing element 11, the period L from the rising of a discharge clock φb to the beginning of clocking of a frame transfer clock φf constitutes an accumulation period during which information charges are accumulated in the image capturing section 11i.

A line transfer clock φv clocks in a cycle identical to that of a frame transfer clock φf, so that information charges for one image screen which are output from the image capturing section 11i at a high speed are sequentially fed to the accumulation section 11v at the same speed. A line transfer clock φv clocks during a period excluding a period for receiving information charges from the image capturing section 11i. In response to single clocking of a line transfer clock φv, information charges accumulated in the accumulation section 11v are sequentially output for every horizontal line to the horizontal transfer section 11h.

It should be noted here that, during normal operation, a line transfer clock φv clocks once every cycle according to a horizontal synchronous signal HT, so that information charges accumulated in one horizontal line in the accumulation section 11v are output to the horizontal transfer section 11h in each horizontal scanning period. In an enhanced operation mode, on the other hand, a line transfer clock φv clocks twice successively in a cycle according to a horizontal synchronous signal HT, as shown in FIG. 3, so that information charges accumulated in two horizontal lines in the accumulation section 11v are output to the horizontal transfer section 11h in each horizontal scanning period.

Because no horizontal transfer clock φh clocks while information charges held in two horizontal lines are transferred to the horizontal transfer section 11h, information charges obtained by two pixels and read from each column of the accumulation section 11v are combined in each bit of the horizontal transfer section 11h. In other words, information charges held in two horizontal lines (rows) in the accumulation section 11v are combined into combined information charges which constitute one combined line in the horizontal transfer section 11h. Thereafter, in response to a horizontal transfer clock φh, information charges constituting a single combined line (combined information charges) in the horizontal transfer section 11h are sequentially output to the output section 11d during a single horizontal period.

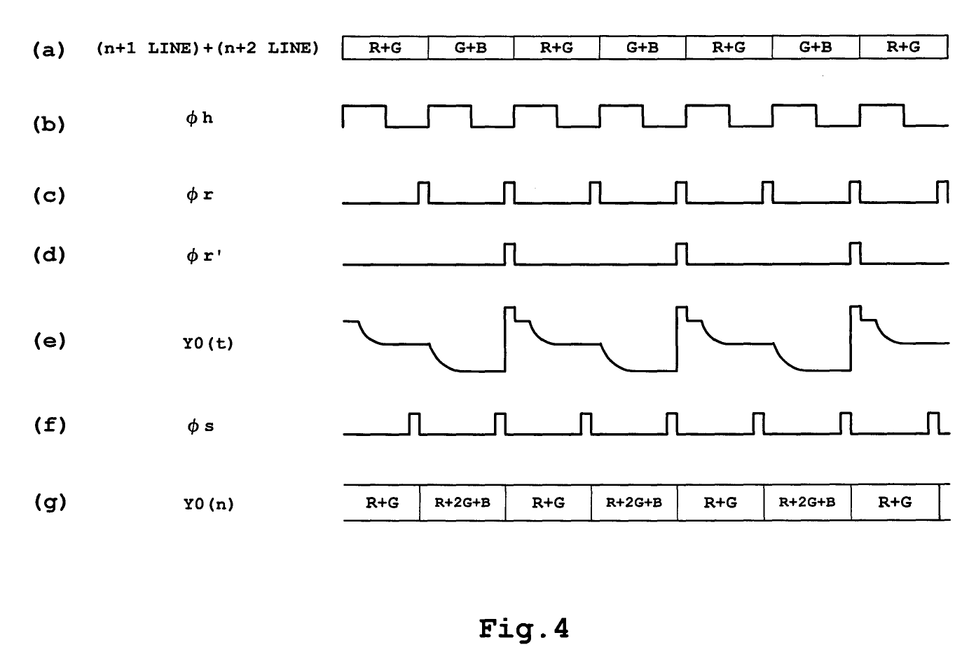

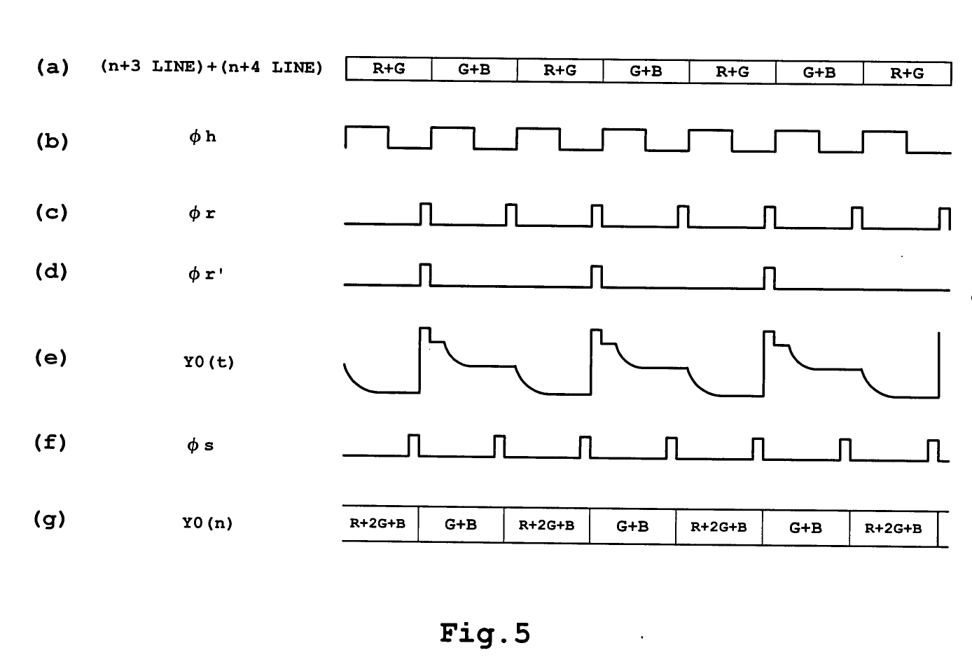

FIGS. 4 and 5 show timings for resetting the output section 11d, sampling by the sample hold circuit 15a, and operation of the A/D conversion circuit 16 in an enhanced mode.

Graphs (a) in FIGS. 4 and 5 show combined information charges to be output from the horizontal transfer section 11h to the output section 11d. As described above, during a process of reading information charges from the accumulation section 11v to the horizontal transfer section 11h, information charges held in two horizontal lines (rows) are combined into combined information charges in a single line. FIG. 4 relates to a case in which information charges held in the (n+1)^{th} and (n+2)^{th} horizontal lines (rows) are combined into one odd-numbered combined line and the resultant combined information charges in the odd-numbered combined line are then horizontally transferred in the horizontal transfer section 11h. FIG. 5 relates to a case in which information charges held in the (n+3)^{th} and (n+4)^{th} horizontal lines (rows) are combined into one even-numbered combined line and the resultant combined information charges in the even numbered-combined line are then horizontally transferred in the horizontal transfer section 11h.

Graphs (b) in FIGS. 4 and 5 show a horizontal transfer clock φh. Graphs (c) in FIGS. 4 and 5 show a reset clock φr for resetting an output from the output section 11d, which repeats charging and discharging according to the information charges output from the horizontal transfer section 11h. Because the cycle of a reset clock φr is generally coincident with that of a horizontal transfer clock φh, the output section 11d is reset, in a normal operation mode, every time when information charges held in one bit of the horizontal transfer section 11h are accumulated in its capacity.

Graphs (d) in FIGS. 4 and 5 show a divided reset clock φr′ for intermittently resetting the output section 11d, so that information charges obtained by two or more pixels are accumulated in the output section 11d. For example, in this device, the cycle of a divided reset clock φr′ is set as long as two cycles of a horizontal transfer clock φh and its phase is displaced by an amount corresponding to one cycle of a horizontal transfer clock φh between an odd-numbered combined line of FIG. 4 and an even-numbered combined line of FIG. 5. Graphs (e) in FIGS. 4 and 5 show an image signal Y0(t) to be output as a voltage change in the output section 11d in the above operation.

Here, in the horizontal transfer section 11h, in either of an odd or even-numbered combined line, combined information charges, that is, <R+G> and <G+B>, originated from two horizontal lines are alternately accumulated (see graphs (a) in FIGS. 4 and 5).

Thereafter, in operation relative to an odd-numbered combined line of FIG. 4, after resetting the output section 11d, combined information charges <R+G> are first transferred from the horizontal transfer section 11h to be accumulated in the output section 11d in response to a horizontal transfer clock φh. Then, the output section 11d outputs a voltage corresponding to the amount of the combined information charges <R+G> as an image signal Y0 (t). Thereafter, combined information charges <G+B> are transferred from the horizontal transfer section 11h to be accumulated in the output section 11d. As a result, combined information charges which were held in two bits of the horizontal transfer section 11h are now accumulated in the capacity of the output section 11d. Therefore, the output section 11d outputs a voltage corresponding to the sum of <R+G> and <G+B> as an image signal Y0 (t). Subsequently, the output section 11d is reset in response to a divided reset clock φr′ whereby the potential on the output side of the output section 11d is reset to a reset level.

In operation relative to an even-numbered combined line of FIG. 5, on the other hand, after resetting the output section 11d, combined information charges <G+B> are first transferred from the horizontal transfer section 11h to be accumulated in the output section 11d in response to a horizontal transfer clock φh. Then, the output side of the output section 11d outputs a voltage corresponding to the amount of the combined information charges <G+B> as an image signal Y0 (t). Thereafter, combined information charges <R+G> are transferred from the horizontal transfer section 11h to be accumulated in the output section 11d. As a result, combined information charges which were held in two bits of the horizontal transfer section 11h are now accumulated in the capacity of the output section 11d. Therefore, the output section 11d outputs a voltage corresponding to the sum of <R+G> and <G+B> as an image signal Y0 (t). Subsequently, the output section 11d is reset in response to a divided reset clock φr′ whereby the potential on the output side of the output section 11d is reset to a reset level.

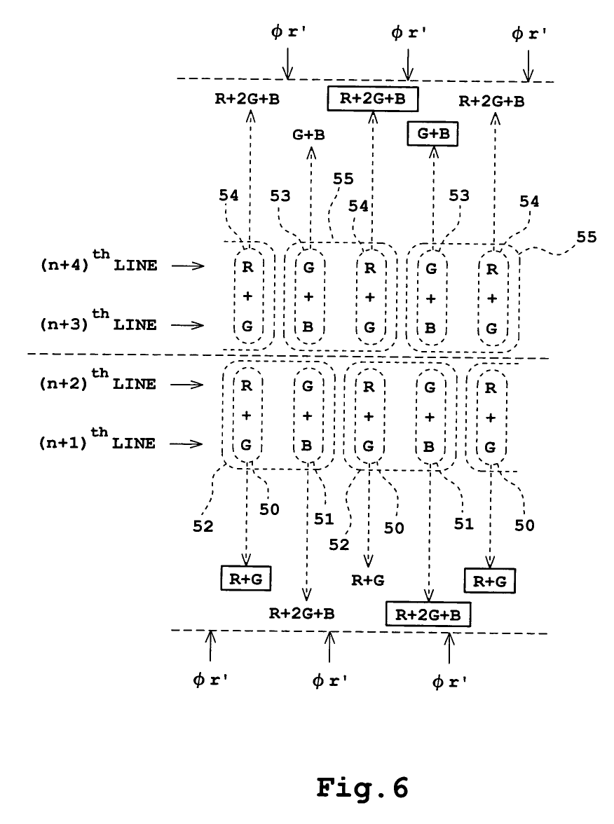

FIG. 6 schematically shows pixel combination and approximate color data when information charges for two lines are combined. In this drawing, the color sensitivity of each pixel in the (n+1)^{th} through (n+4)^{th} horizontal lines (rows) of the image capturing section 11i is denoted using R, G, or B.

During the transfer from the accumulation section 11v to the horizontal transfer section 11h, information charges in the (n+1)^{th} and (n+2)^{th} rows are combined into an odd-numbered combined line of FIG. 4 in the horizontal transfer section 11h. Meanwhile, information charges in the (n+3)^{th} and (n+4)^{th} rows are combined into an even-numbered combined line of FIG. 5 in the horizontal transfer section 11h.

That is, for an odd-numbered combined line, combined information charges <R+G> which are obtained by combining information charges originated from the pixel block 50, and combined information charges <G+B> which are obtained by combining information charges originated from the pixel block 51, are alternately accumulated in the respective bits of the horizontal transfer section 11h. Thereafter, through the operation of FIG. 4, combined information charges <G+B> originated from the pixel block 50 and combined information charges <R+2G+B> (<R+G>+<G+B>) originated from the pixel block 52 are alternately held in the output section 11d in synchronism with a divided reset clock φ r′.

For an even-numbered combined line, on the other hand, combined information charges <G+B> which are obtained by combining information charges originated from the pixel block 53 and combined information charges <R+G> which are obtained by combining information charged originated from the pixel block 54 are alternately accumulated in the respective bits of the horizontal transfer section 11h. Thereafter, through the operation of FIG. 5, the combined information charges <G+B> originated from the pixel block 53 and combined information charges R+2G+B (<R+G>+<G+B>) originated from the pixel block 55 are alternately held in the output section lid in synchronism with a divided reset clock φ r′.

Graphs (f) in FIGS. 4 and 5 show a sampling clock φs, which has a cycle identical to that of a horizontal transfer clock φ h, as described above. The sample hold circuit 15a samples an image signal Y0(t) in synchronism with a clock φs. As a result, the sample hold circuit 15a alternately samples an image signal Y0(t) indicating a voltage corresponding to the amount of combined information charges of one packet and an image signal Y0(t) indicating a voltage corresponding to the amount of combined information charges of two pockets, and generates an image signal Y1 (t), which is then supplied to a A/D conversion circuits 16.

Here, a sampling clock for A/D conversion DCK to be supplied to the A/D conversion circuit 16 has a cycle identical to that of the horizontal transfer clock φh, similar to a sampling clock φ s, as described above. In response to a sampling clock DCK, the A/D conversion circuit 16 converts an analogue signal Y1 (t) to a digital signal Y0 (t). Graphs (g) in FIGS. 4 and 5 show image data Y0 (t) output from the A/D conversion circuit 16.

As a result of the above, in an operation relative to an odd-numbered combined line of FIG. 4, the A/D conversion circuit 16 alternately outputs, as image data Y0(n), data D (R+G) in accordance with the amount of combined information charges <R+G> (that is, image information originated from the pixel block 50) and data D (R+2G+B) in accordance with the amount of combined information charges <R+G>+<G+B>, or <R+2G+B> (that is, image information originated from the pixel block 52).

Meanwhile, in an operation relative to an even-numbered combined line of FIG. 5, the A/D conversion circuit 16 alternately outputs, as image data Y0(n), data D<G+B> in accordance with the amount of combined information charges <G+B> (that is, image information originated from the pixel block 53) and data D (R+2G+B) in accordance with the amount of combined information charges (<R+G>+<G+B>) (that is, image information originated from the pixel block 55).

In an enhanced operation mode, the brightness data generating circuit 18 receives image data Y0(n) from the A/D conversion circuit 16 and generates brightness data Y. Specifically, the brightness data generating circuit 18 may add D(R+G), D(R+2G+B), D(G+B), and D(R+2G+B) and averages the added result, so that the resulting average is used as brightness data Y. That is, brightness data Y is data obtained by combining information charges and enables a larger signal level even under low illumination image capturing condition. Therefore, use of brightness data Y as a brightness signal enables enhanced sensitivity of an image capturing device.

Meanwhile, the color separating circuit 19 separates data D (R+G) from an image data Y0 (n), as shown in FIG. 6, to use as color component data R′(n), which approximates red component, and also separates data D (R+B) to use as color component data B′(n), which approximates blue component. Further, the color separating circuit 19 adds D(R+2G+B) contained in an odd-numbered combined line and D(R+2G+B) contained in an even-numbered combined line and multiplies the result by, for example, ¼, so that the resultant data D(1/2·R+G+1/2·B) is used as green component data G′(n), which approximates green component data.

The color separating circuit 19 incorporates a line memory, similar to the brightness data generating circuit 18, so that it can interpolate image information which is absent in a received line. For example, when the color separating circuit 19 receives data on a line which contains image information, for example, R+G and R+2G+B, image information which is not contained in the line, that is, G+B in this case, can be interpolated based on image information contained in other lines stored in the line memory.

It should be noted that, although information charges for two lines are combined while transferring them from a vertical shift register to a horizontal shift register in the above embodiment, the number of lines to be combined is not limited to two and information charges for three or more lines may be combined.

It should also be noted that frequency dividing of a reset clock φr to generate a divided reset clock φr′ is not limited to ½. That is, factors for multiplication of the cycle of a reset operation are not limited by the present invention, and may be selected as desired or determined appropriate, and another application. Alternatively, an application in which a reset cycle is extended while lines are not combined may be possible, and another application in which lines are combined while a reset cycle is not extended is also possible. In the latter case, a divided reset clock φr′ has an identical cycle to that of a reset clock φr.

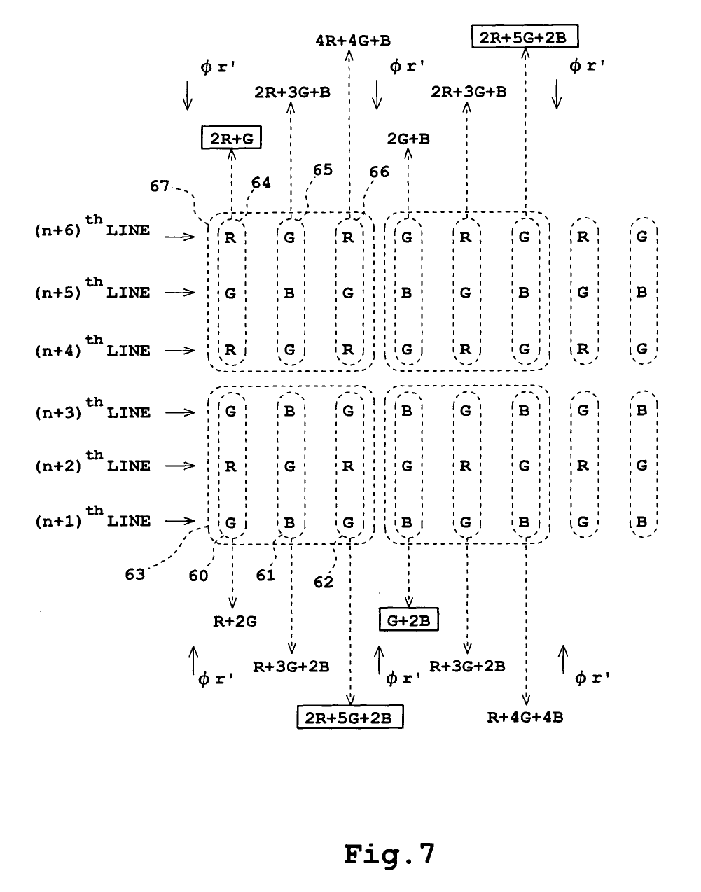

FIG. 7 schematically shows pixel combining and approximate color data when information charges held in three lines are combined in a second embodiment. In this embodiment, a reset cycle is extended by a factor of three. In this drawing, the color sensitivity of each pixel in the (n+1)^{th} through (n+6)^{th} rows of the image capturing section 11i is denoted using R, G, or B.

While transferring from the accumulation section 11v to the horizontal transfer section 11h, information charges in the (n+1)^{th} through (n+3)^{th} rows are combined into a combined line originated from three lines in the horizontal transfer section 11h. On the other hand, information charges in the (n+4)^{th} through (n+6)^{th} rows are combined into a combined line originated from three lines in the horizontal transfer section 11h.

That is, when combining the (n+1)^{th} through (n+3)^{th} rows, combined information charges <R+2G> obtained by combining information charges originated from the pixel block 60, combined information charges <G+2B> obtained by combining information charges originated from the pixel block 61, and combined information charges <R+2G> obtained by combining information charges originated from the pixel block 62 are alternately accumulated in the respective bits of the horizontal transfer section 11h.

Then, after resetting the output section 11d in response to a divided reset clock φr′, the combined information charges <R+2G> originated from the pixel block 60, the accumulated combined information charges <R+3G+2B> originated from the pixel block 61, and the accumulated combined information charges <2R+5G+2B> originated from the pixel block 62 are accumulated in the output section 11d. Further, after resetting the output section 11d in response to a divided reset clock φr′, similarly, the combined information charges <G+2B>, <R+3G+2B>, and <2R+4G+4B> are sequentially accumulated in the output section 11d.

Meanwhile, when combining the (n+4)^{th} through (n+6)^{th} rows, combined information charges <2R+G> obtained by combining information charges originated from the pixel block 64, combined information charges <2G+B> obtained by combining information charges originated from the pixel block 65, and combined information charges <2R+G> obtained by combining information charges originated from the pixel block 66 are alternately accumulated in the respective bits of the horizontal transfer section 11h.

Then, after resetting the output section 11d in response to a divided reset clock φr′, the combined information charges <2R+G> originated from the pixel block 64, the accumulated combined information charges <2R+3G+B> originated from the pixel block 65, and the accumulated combined information charges <4R+4G+B> originated from the pixel block 66 are accumulated in the output section 11d. Further, after resetting the output section 11d in response to a divided reset clock φr′, similarly, the combined information charges <2G+B>, <2R+3G+B>, and <2R+5G+2B> are similarly accumulated in the output section 11d.

In the color separating circuit 19, data D (2R+G) is separated from the image data Y0 (n), as shown in FIG. 7, to be used as color component data R′(n), which approximates the red component, while data D (G+2B) is separated to be used as color component data B′(n), which approximates the blue component. Moreover, the color separating circuit 19 adds data D(2R+5G+2B) contained in the combined line originated from the (n+1)^{th} through (n+3)^{th} lines and data D(2R+5G+2B) contained in the combined line originated from the (n+4)^{th} through (n+6)^{th} lines and then multiplies the result by, for example, ⅓, so that the resultant data D(2/3·R+5/3·G+2/3·B) is used as green component data G′(n), which approximates green component data.

FIG. 8 schematically shows pixel combining and approximate color data when information charges held in four lines are combined in a third embodiment of the present invention. In this embodiment, a reset cycle is extended by a factor of four. In this drawing, the color sensitivity of each pixel in the (n+1)^{th} through (n+8)^{th} lines of the image capturing section 11i is denoted using R, G, or B.

While transferring from the accumulation section 11v to the horizontal transfer section 11h, information charges in the (n+1)^{th} through (n+4)^{th} lines are combined into a combined line originated from four lines in the horizontal transfer section 11h. On the other hand, information charges in the (n+5)^{th} through (n+8)^{th} lines are combined into a combined line originated from four lines in the horizontal transfer section 11h.

That is, in an operation relative to the (n+1)^{th} through (n+4)^{th} lines, combined information charges <2R+2G> obtained by combining information charges originated from the pixel block 70, combined information charges <2G+2B> obtained by combining information charges originated from the pixel block 71, combined information charges <2R+2G> obtained by combining information charges originated from the pixel block 72, and combined information charges <2G+2B> obtained by combining information charges held in the pixel block 73 are alternately accumulated in the respective bits of the horizontal transfer section 11h. Thereafter, after resetting the output section 11d, the combined information charges <2R+2G> originated from the pixel block 70, the accumulated combined information charges <2R+4G+2B> originated from the pixel block 71, the accumulated combined information charges <4R+6G+2B> originated from the pixel block 72, and the accumulated combined information charges <4R+8G+4B> originate d from the pixel block 73 are accumulated in the output section lid in synchronism with a divided reset clock φr′.

Meanwhile, in an operation relative to the (n+5)^{th} through (n+8)^{th} lines, combined information charges <2G+2B> obtained by combining information charges held in the pixel block 75, combined information charges <2R+2G> obtained by combining information charges held in the pixel block 76, combined information charges <2G+2B> obtained by combining information charges held in the pixel block 77, and combined information charges <2R+2G> obtained by combining information charges held in the pixel block 78 are alternately accumulated in the respective bits of the horizontal transfer section 11h. Then, after resetting the output section 11d, the combined information charges <2G+2B> originated from the pixel block 75, the accumulated combined information charges <2R+4G+2B> originated from the pixel block 76, the accumulated combined information charges <2R+6G+4B> originated from the pixel block 76, and the accumulated combined information charges <4R+8G+4B> originated from the pixel block 78 are accumulated in the output section 11d in synchronism with a divided reset clock φr′.

In the color separating circuit 19, data D (4R+6G+2B) is separated from the image data Y0 (n), as shown in FIG. 8, and multiplies by 1/6, so that the resultant data D (2/3·R+G+1/3·B) is used as color component data R′(n), which approximates the red component. Further, data D (2R+6G+4B) is separated from the image data Y0 (n) and then multiplied by ⅙, so that the resultant data D(1/3·R+G+2/3·B) is used as color component data B′(n), which approximates the blue component. Still further, the color separating circuit 19 adds data D(4R+8G+4B) contained in the combined line originated from the (n+1)^{th} through (n+4)^{th} rows and data D(4R+8G+4B) contained in the combined line originated from the (n+5)^{th} through (n+8)^{th} rows and then multiplies the result by, for example, 1/16, so that the resultant data D(1/2·R+G+1/2·B) is used as green component data G′(n) which approximates the green component data. In the above, because pixels in a larger area tend to be assigned to green components, priority is given to the processing for obtaining approximate color data for the red and blue components.

As described above, color component data which approximate the respective colors are generated using combined information charges which contain charges for red, green, and blue components at different ratios in the above. Alternatively, color component data which faithfully express true colors may be generated through calculation using the combined information charges which contain charges for red, green, and blue components at different ratios.

It should be noted that, when an electronic flash is used in actual image capturing, an image capturing device can acquire sufficient sensitivity in a normal operation mode and thus provide a bright image at a high resolution. Meanwhile, an enhanced operation mode is used in an attempt of capturing an object image without using an electronic flash or the like, for example, to obtain an object image to be shown on a view finder so that the user can check the object by looking at the displayed image before actually capturing an image. That is, an enhanced operation mode is mainly used under low illumination image capturing conditions in which the object is barely shown, in order to capture a rough image of the object. These are situations in which deteriorated resolution and inaccurate color balance due to pixel combination acceptable.

As described above, when color component data R′(n), G′(n), and B′(n) obtained in an enhanced operation mode are used intact in generation of a brightness signal and a color difference signal, it is possible to obtain image information with improved sensitivity without modifying the device structure of a solid image capturing element. As a result, cost increases can be remarkably suppressed, which allows wider installation of such digital cameras in a small size device such as a portable phone.

An alternate structure is applicable in which an additional circuit is provided for color balance correction relative to color component data R′(n), G′(n), and B′(n) so that amore faithful image of an object can be displayed in colors closer to its original colors.

It should also be noted that, although an image capturing device which employs a solid image capturing element of a frame transfer type is referred to in the above, application of the present invention is not limited to that type of device. The present invention can be applied to an image capturing device using a solid image capturing element of an interline type or any other suitable image capturing device.

What is claimed is:

1. An image capturing device, comprising:
a solid image capturing element having a plurality of light receiving pixels arranged in a matrix, for accumulating information charges therein, the light receiving pixels in an odd-numbered line being alternately correlated to a first color component and a second color component and the light receiving pixels in an even-numbered line being alternately correlated to the second color component and a third color component, the light receiving pixels being connected to a plurality of vertical shift registers, outputs from the plurality of vertical shift registers being respectively coupled to respective bits of a horizontal shift register, an output from the horizontal shift register being coupled to an output section;
a driving circuit for transferring the information charges accumulated in the plurality of light receiving pixels from the plurality of vertical shift registers to the horizontal shift register, for combining, during a process of transferring the information charges, the information charges for every k-number of lines (k being a natural number) to thereby create a first combined charge and a second combined charge which are alternately accumulated in the respective bits of the horizontal shift register, the first combined charge being a combination of the first color component and the second color component, the second combined charge being a combination of the second color component and the third color component, and for accumulating the first combined charge and the second combined charge, sent from the horizontal shift register in the units of one bits, for m-number of bits (m being a natural number, either k or m being larger than one) in the output section to thereby create a first output, a second output, and a third output, the first output being a combination of the first color component, the second color component, and the third color component weighted according to a first ratio, the second output being a combination of the first color component, the second color component, and the third color component weighted according to a second ratio, and the third output being a combination of the first color component, the second color component, and the third color component weighted according to a third ratio;
a sample hold circuit for sampling an output from the solid image capturing element to produce a first image signal in response to the first output, a second image signal in response to the second output, and a third image signal in response to the third output; and
a signal processing circuit for applying predetermined signal processing to an image signal produced by the sample hold circuit,
wherein
the signal processing circuit generates color component signals respectively expressing the first color component, the second color component, and the third color component, using the first image signal, the second image signal, and the third image signal.

2. The image capturing device according to claim 1, wherein the first color component, the second color component, and the third color component are three optical primary colors, that is, red, green, and blue, and the second color component is green.

3. The image capturing device according to claim 1, wherein the information charges are combined for every three lines and the combined charges held in three bits of the horizontal shift register are accumulated in the output section.

4. The image capturing device according to claim 1, wherein the information charges are combined for every four lines and the combined charges held in four bits of the horizontal shift register are accumulated in the output section.

5. An image capturing device, comprising:
a solid image capturing element having a plurality of light receiving pixels arranged in a matrix, for accumulating information charges therein, the light receiving pixels in an odd-numbered line being alternately correlated to a first color component and a second color component and the light receiving pixels in an even-numbered line being alternately correlated to the second color component and a third color component, the light receiving pixels being connected to a plurality of vertical shift registers, outputs from the plurality of vertical shift registers being respectively coupled to respective bits of a horizontal shift register, an output from the horizontal shift register being coupled to an output section;
a driving circuit for transferring the information charges accumulated in the plurality of light receiving pixels from the plurality of vertical shift registers to the horizontal shift register, for combining, during a process of transferring the information charges, the information charges for every k-number of lines (k being a natural number) to thereby create a first combined charge and a second combined charge which are alternately accumulated in the respective bits of the horizontal shift register, the first combined charge being a combination of the first color component and the second color component, the second combined charge being a combination of the second color component and the third color component, and for accumulating the first combined charge and the second combined charge, sent from the horizontal shift register in the units of one bits, for m-number of bits (m being a natural number, either k or m being larger than one) in the output section to thereby create a first output, a second output, and a third output, the first output being a combination of the first color component, the second color component, and the third color component weighted according to a first ratio, the second output being a combination of the first color component, the second color component, and the third color component weighted according to a second ratio, and the third output being a combination of the first color component, the second color component, and the third color component weighted according to a third ratio;
a sample hold circuit for sampling an output from the solid image capturing element to produce a first image signal in response to the first output, a second image signal in response to the second output, and a third image signal in response to the third output; and
a signal processing circuit for applying predetermined signal processing to an image signal produced by the sample hold circuit,
wherein
the signal processing circuit generates a color component signal which approximates at least one color component among the first color component, the second color component, and the third color component, using the first image signal, the second image signal, and the third image signal.

6. The image capturing device according to claim 5, wherein the first color component, the second color component, and the third color component are three optical primary colors, that is, red, green, and blue, and the second color component is green.

7. An image capturing device, comprising:
a solid image capturing element having a plurality of light receiving pixels arranged in a matrix, for accumulating information charges therein, the light receiving pixels in an odd-numbered line being alternately correlated to a first color component and a second color component and the light receiving pixels in an even-numbered line being alternately correlated to the second color component and a third color component, the light receiving pixels being connected to a plurality of vertical shift registers, outputs from the plurality of vertical shift registers being respectively coupled to respective bits of a horizontal shift register, an output from the horizontal shift register being coupled to an output section;
a driving circuit for transferring the information charges accumulated in the plurality of light receiving pixels from the plurality of vertical shift registers to the horizontal shift register, for combining, during a process of transferring the information charges, the information charges for every two lines to thereby create a first combined charge and a second combined charge which are alternately accumulated in the respective bits of the horizontal shift register, the first combined charge being a combination of the first color component and the second color component, the second combined charge being a combination of the second color component and the third color component, and for accumulating the first combined charge and the second combined charge, sent from the horizontal shift register in the units of one bits, for two bits in the output section to thereby create a first output and a second output, the first output being in according with an amount of the first combined charge or the second combined charge and the second output being in accordance with an amount of the first combined charge and the second combined charge;
a sample hold circuit for sampling an output from the solid image capturing element to produce a first image signal in response to the first output and a second image signal in response to the second output and
a signal processing circuit for applying predetermined signal processing to an image signal produced by the sample hold circuit,
wherein
the signal processing circuit generates a first color component signal which approximates the first color component or the third color component, using the first image signal, and a second color component signal which approximates the second color component, using the second image signal.

8. The image capturing device according to claim 7, wherein the first color component, the second color component, and the third color component are three optical primary colors, that is, red, green, and blue, and the second color component is green.
